(19) United States
(12) Patent Application Publication
(10) Pub. No.: US 2016/0041021 A1
(43) Pub. Date: Feb. 11, 2016

(54) CAPACITIVE LIQUID LEVEL DETECTION DEVICE

(71) Applicant: Sumitomo Riko Company Limited, Aichi (JP)

(72) Inventors: Yuuki SAITOU, Aichi (JP); Tetsuyoshi SHIBATA, Aichi (JP); Keisuke KAWADE, Aichi (JP); Atsushi MURAMATSU, Aichi (JP)

(73) Assignee: SUMITOMO RIKO COMPANY LIMITED, Aichi (JP)

(21) Appl. No.: 14/886,178

(22) Filed: Oct. 19, 2015

Related U.S. Application Data
(63) Continuation of application No. PCT/JP2014/065782, filed on Jun. 13, 2014.

(30) Foreign Application Priority Data
Jun. 19, 2013 (JP) 2013-128268

(51) Int. Cl. G01F 23/26

(52) U.S. Cl. CPC G01F 23/26

(57) ABSTRACT

Provided is a capacitive liquid level detection device capable of determining liquid level and liquid quality. This detection device comprises a plurality of electrode pairs disposed at different positions in a height direction in a tank for storing liquid; a measuring instrument for acquiring values equivalent to capacitance between respective electrode pairs of the plurality of electrode pairs; a storage part for storing a plurality of threshold values determined based on values equivalent to capacitance between one of the electrode pairs in the presence of the air or a plurality of kinds of liquids; and a determination part comparing the values equivalent to capacitance between the respective electrode pairs with each of the threshold values, and the determination part determines for determining liquid level corresponding to liquid quality based on the comparison result.

### CROSS-REFERENCE TO RELATED APPLICATION

This is a continuation of Application PCT/JP2014/065782, filed on Jun. 13, 2014, which is incorporated herein by reference. The present invention is based on Japanese Patent Application No. 2013-128268, filed on Jun. 19, 2013, the entire contents of which are incorporated herein by reference.

### BACKGROUND OF THE INVENTION

1. Field of the Invention

The present invention relates to a capacitive liquid level detection device for detecting liquid level of liquids in a tank.

2. Description of the Related Art

Patent Document 1 discloses detection of liquid level by placing electrode pairs at a plurality of measurement points along a reference line extending from a lower position toward a higher position, respectively and determining whether liquid is present or not at the measurement points by determining whether capacitance between the respective electrode pairs exceeds a reference value or not.

Moreover, Patent Document 2 discloses detection of liquid level by placing a plurality of detection electrode pairs and a reference electrode pair and determining whether the respective detection electrode pairs are immersed in liquid or not based on a capacitance difference between the respective detection electrode pairs and the reference electrode pair.
[PTL 1] Japanese Unexamined Patent Application Publication No. H11-311,562
[PTL 2] Japanese Unexamined Patent Application Publication No. 2006-337,173

### SUMMARY OF THE INVENTION

By the way, when a plurality of kinds of liquids are stored in a tank, it is requested to know liquid quality in the tank.

The present invention has been made in view of these circumstances. It is an object of the present invention to provide a capacitive liquid level detection device capable of determining liquid level and liquid quality.

A capacitive liquid level detection device according to the present invention comprises a plurality of electrode pairs disposed at different positions in a height direction in a tank for storing liquid; a measuring instrument for acquiring values equivalent to capacitance between respective electrode pairs of the plurality of electrode pairs; a storage part for storing a plurality of threshold values determined based on values equivalent to capacitance between one of the plurality of electrode pairs in the presence of the air or a plurality of kinds of liquids; and a determination part comparing the values equivalent to capacitance between the respective electrode pairs of the plurality of electrode pairs with each of the plurality of threshold values, and the determination part determines for determining liquid level corresponding to liquid quality based on the comparison result.

Thus, the plurality of threshold values stored in the storage part are determined based on values equivalent to capacitance between one of the plurality of electrode pairs in the presence of the air or a plurality of kinds of liquids. Here, capacitance between an electrode pair has different values depending on a variety of factors such as surface shape of electrodes of the electrode pair, directions of the electrodes, and a member for fixing the electrode pair. Therefore, a plurality of threshold values are respectively determined based on values equivalent to capacitance between one of the plurality of electrode pairs in the presence of the air or a plurality of kinds of liquids. Accordingly, liquid level corresponding to liquid quality can be reliably determined.

Preferred embodiments of the capacitive liquid level detection device according to the present invention will be described hereinafter.

Preferably, the plurality of threshold values stored in the storage part are a plurality of liquid quality determination threshold values corresponding to the kind of liquid; and the determination part compares the values equivalent to capacitance between the respective electrode pairs with each of the plurality of liquid quality determination threshold values, and the determination part determines liquid quality of liquid present at positions of the respective electrode pairs of the plurality of electrode pairs based on the comparison result.

That is to say, the plurality of liquid quality determination threshold values correspond to values equivalent to capacitance between electrode pairs in the presence of the plurality of kinds of liquids, respectively. For example, the liquid quality determination threshold values include a threshold value corresponding to the air, a threshold value corresponding to gasoline, a threshold value corresponding to water, and so on. Since the determination part can determine liquid quality of liquid present at positions of the respective electrode pairs, it is possible to know which kind of liquid is present at which height (position). That is to say, liquid level of the respective liquids can be determined.

Furthermore, preferably, when a value equivalent to capacitance between the one of the plurality of electrode pairs in the presence of the air is defined as an air reference value, and values equivalent to capacitance between the one of the plurality of electrode pairs in the presence of the plurality of kinds of liquids are respectively defined as liquid reference values, the plurality of liquid quality determination threshold values are respectively determined based on values obtained by dividing the liquid reference values with the air reference value, and the determination part calculates values by dividing the capacitance equivalent values acquired by the measuring instrument with the air reference value, the determination part compares the calculated values with each of the plurality of liquid quality determination threshold values, the determination part determines liquid level corresponding to liquid quality based on the comparison result.

The liquid quality determination threshold values are determined by using the air reference value and the respective liquid reference values. Therefore, even when capacitance is varied by a variety of factors between respective ones of the plurality of electrode pairs, the determination part can determine the kind of liquid present at the positions of the respective electrode pairs without affected by the variety of factors.

Preferably, the storage part stores the plurality of liquid quality determination threshold values corresponding to the kind of liquid for each of the plurality of electrode pairs; and the determination part extracts a plurality of liquid quality determination threshold values corresponding to the electrode pair as the determination target among the plurality of liquid quality determination threshold values, the determination part compares the extracted plurality of liquid quality determination threshold values with a value equivalent to capacitance between the electrode pair as the determination target, and the determination part determines liquid quality of a liquid present at a position of an electrode pair as a determination target of the plurality of electrode pairs based on the comparison result.

Even if the same kind of liquid is present therebetween, sometimes measured capacitance equivalent values vary with the position of an electrode pair. Therefore, the storage part stores different liquid quality determination threshold values for each of the plurality of electrode pairs. Liquid quality of liquid present at a position of an electrode pair as a determination target can be reliably determined by comparing a plurality of liquid quality determination threshold values corresponding to the electrode pair as the determination target and a capacitance equivalent value.

Preferably, the plurality of threshold values stored in the storage part are a plurality of boundary surface determination threshold values corresponding to differences in values equivalent to capacitance between the one of the plurality of electrode pairs in the presence of the air or and the plurality of kinds of liquids; and the determination part compares a difference between a value equivalent to capacitance between one electrode pair of the two different electrode pairs and a value equivalent to capacitance between the other pair with each of the plurality of boundary surface determination threshold values, and the determination part determines that different fluids are present in a gap in a height direction between two different electrode pairs of the plurality of electrode pairs based on the comparison result.

Here, when respective values equivalent to capacitance between two different electrode pairs have a great difference, it is assumed that different fluids are present in a gap in a height direction between these two electrode pairs. Whether different fluids are present in the gap in the height direction between these two electrode pairs or not can be determined by setting a plurality of boundary surface determination threshold values and comparing a difference between the capacitance equivalent values with the plurality of boundary surface determination threshold values. That is to say, liquid level of respective liquids can be determined by grasping boundary surfaces of the respective fluids.

Preferably, the capacitive liquid level detection device comprises a plurality of first electrode pair units disposed at different positions in the height direction in the tank, each of the plurality of first electrode pair units comprising a plurality of first electrode pairs disposed at different positions in the height direction, and each of the plurality of first electrode pairs in one of the plurality of first electrode pair units and any one of the plurality of first electrode pairs in another of the plurality of first electrode pair units being connected by the same wiring; and a plurality of second electrode pairs respectively disposed around positions of the plurality of first electrode pair unit.

Moreover, the storage part stores the plurality of threshold values corresponding to the respective units of the plurality of first electrode pair units, and the storage part stores a plurality of second determination threshold values for determination using the plurality of second electrode pairs. The determination part compares values equivalent to capacitance between the respective electrode pairs of the plurality of second electrode pairs with each of the plurality of second determination threshold values, the determination part compares values equivalent to capacitance between the plurality of first electrode pairs constituting each of the plurality of first electrode pair units with each of the plurality of threshold values, and the determination part determines liquid level corresponding to liquid quality based on the comparison results.

Each of the plurality of first electrode pairs in one of the plurality of first electrode pair units is connected to any one of the plurality of first electrode pairs in another of the plurality of first electrode pair units by the same wiring. Therefore, the volume of wiring can be reduced. However, because different first electrode pairs are connected to each other by the same wiring, it is impossible to determine between which first electrode pair of the different first electrode pairs a certain liquid is present. The determination part can determine which unit should be selected among the plurality of first electrode pair units by using a plurality of second electrode pairs.

Furthermore, the storage part stores the plurality of threshold values corresponding to the respective units of the first electrode pair units, and stores a plurality of second determination threshold values. Therefore, the determination part can determine liquid level corresponding to liquid quality by comparing values equivalent to capacitance between the respective electrode pairs of the plurality of second electrode pairs and each of the plurality of second determination threshold values, and comparing values equivalent to capacitance between the plurality of first electrode pairs constituting each of the plurality of first electrode pair units and each of the plurality of threshold values.

Moreover, preferably, the tank is a vehicle fuel tank having a depression in a bottom; the capacitive liquid level detection device comprises an electrode unit fixed in a vertical gap between the depression of the tank and a ceiling of the tank; and the electrode unit comprises a unit body having a bar shape, comprising the plurality of electrode pairs, and having a lower end disposed in the depression, and an urging member disposed at an upper end of the unit body, urging the unit body in an extension direction and exerting pressure to the ceiling of the tank.

In this way, a lower end of a unit body is disposed in a depression in a tank and an urging member provided at an upper end of the unit body exerts pressure to a ceiling of the tank. Therefore, the electrode unit can be reliably fixed to the tank.

Here, liquid in a tank of a vehicle moves due to vibrations in a lateral direction of the vehicle. Therefore, if the electrode unit is disposed in a center in the lateral direction of the vehicle in the tank, the electrode unit is less susceptible to vibrations of liquid in the tank. In this case, liquid level can be detected with high accuracy.

### BRIEF DESCRIPTION OF THE DRAWINGS

FIG. 1 shows a structure of a fuel tank and a capacitive liquid level detection device of the present embodiments.

FIG. 2 shows a detailed structure of a unit body of FIG. 1 in Example 1.

FIG. 3 shows information stored in a storage part in Example 1.

FIG. 4 shows dielectric constants and capacitance equivalent values of the air, gasoline, methanol and water.

FIG. 5 shows specific gravity of the air, gasoline, methanol and water.

FIG. 6 is a flowchart of a liquid quality determination process performed by a determination part in Example 1.

FIG. 7 shows information stored in the storage part in Example 2.

FIG. 8 is a flowchart of a liquid quality determination process performed by the determination part in Example 2.

FIG. 9 is a side view of a unit body of an electrode unit in Example 3.

FIG. 10 shows information stored in the storage part in Example 3.

FIG. 11 is a flowchart of a liquid quality determination process performed by the determination part in Example 3.

FIG. 12 shows information stored in the storage part in Example 4.

FIG. 13 is a flowchart of a liquid quality determination process performed by the determination part in Example 4.

FIG. 14 is a side view of a unit body of an electrode unit in Example 5.

FIG. 15 shows information stored in the storage part in Example 5.

FIG. 16 shows information stored in the storage part in Example 6.

FIG. 17 is a flowchart of a liquid quality determination process performed by the determination part in Example 6.

FIG. 18 shows a detailed structure of a unit body in Example 7.

FIG. 19 shows a detailed structure of a unit body in Example 8.

FIG. 20 is a flowchart of a liquid quality determination process performed by the determination part in Example 8.

### DETAILED DESCRIPTION OF THE PREFERRED EMBODIMENTS

### Example 1

### 1. Overall Structure of Capacitive Liquid Level Detection Device

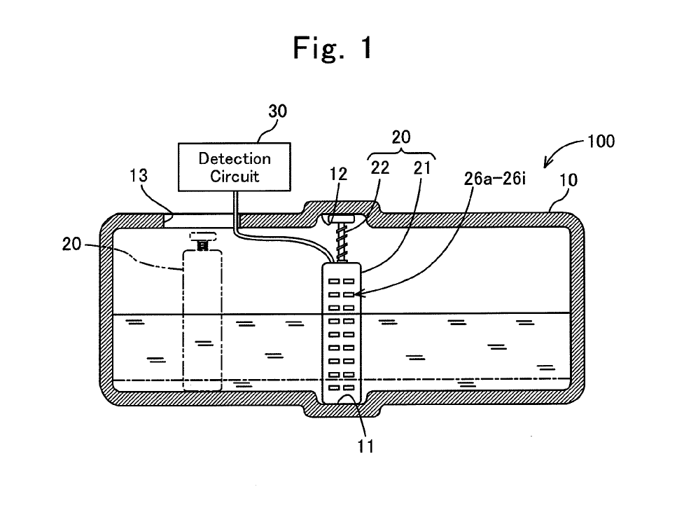

A structure of a capacitive liquid level detection device (hereinafter referred to as a liquid level detection device) will be described with reference to FIG. 1. The liquid level detection device detects liquid level and liquid quality in a fuel tank 10 of a vehicle. The fuel tank 10 is mounted on the vehicle and stores gasoline as fuel as shown in FIG. 1. Here, supplied liquid may sometimes contain water or methanol besides gasoline. The liquid level detection device determines liquid quality of liquid in the fuel tank 10, that is to say, whether the liquid is gasoline, water, methanol or the like. Furthermore, the liquid level detection device determines liquid level of liquids, that is to say, liquid level of gasoline, liquid level of water and liquid level of methanol. When there is another kind of liquid or a floating matter, for instance, the liquid level detection device can also be used for determining these materials.

The fuel tank 10 has a depression 11 in a center in a vehicle lateral direction in a bottom, and also has a depression 12 on a portion of a ceiling corresponding to the depression 11. That is to say, the depression 11 in the bottom and the depression 12 on the ceiling face each other in a vertical direction. Moreover, an upper surface of the fuel tank 10 has an opening 13. A detachable connector is connected through the opening 13.

The fuel tank 10 is provided with an electrode unit 20 constituting a capacitive liquid level detection device 100. The electrode unit 20 is located in a center in a vehicle lateral direction and fixed in a vertical gap between the depression 11 in the bottom and the depression 12 on the ceiling in the fuel tank 10.

The electrode unit 20 comprises a unit body 21 formed in a bar shape, and an urging member 22 provided at an upper end of the unit body 21 and extendable from an upper end surface of the unit body 21. A lower end of the unit body 21 is disposed in the depression 11 in the bottom of the fuel tank 10. When extended, the urging member 22 exerts pressure (in an extension direction) to the depression 12 of the ceiling of the fuel tank 10. Owing to this structure, the electrode unit 20 is fixed between the depression 11 in the bottom and the depression 12 on the ceiling of the fuel tank 10.

In this respect, the electrode unit 20 is inserted into the fuel tank 10 through the opening 13, as shown by two-dot chain line in FIG. 1. At this time, the urging member 22 is contracted. While the urging member 22 is contracted, the unit body 21 of the electrode unit 20 is located in the depression 11 in the bottom, and then the urging member 22 is extended to exert pressure to the depression 12 of the ceiling.

Having the above structure, the electrode unit 20 can be reliably inserted into the fuel tank 10 even if the opening 13 is located off a center in a vehicle lateral direction, and can be reliably located in the center in the vehicle lateral direction.

Furthermore, the unit body 21 comprises a plurality of electrode pairs 26a to 26i disposed at different positions in a vertical direction (a height direction) in the fuel tank 10. Capacitance between each electrode pair of the plurality of electrode pairs 26a to 26i is different with the kind of fluid present therebetween.

The liquid level detection device 100 comprises a detection circuit 30 electrically connected to the plurality of electrode pairs 26a to 26i of the electrode unit 20. The detection circuit 30 is disposed outside the fuel tank 10. The detection circuit 30 applies voltage to one electrode of each electrode pair of the plurality of electrode pairs 26a to 26i and acquires potential of the other electrode. Then the detection circuit 30 calculates a capacitance equivalent value Cx between each electrode pair of the plurality of electrode pairs 26a to 26i based on the acquired potential. The detection circuit 30 determines liquid level and liquid quality of liquid in the fuel tank 10 based on the calculated capacitance equivalent values Cx.

### 2. Unit Body of Electrode Unit

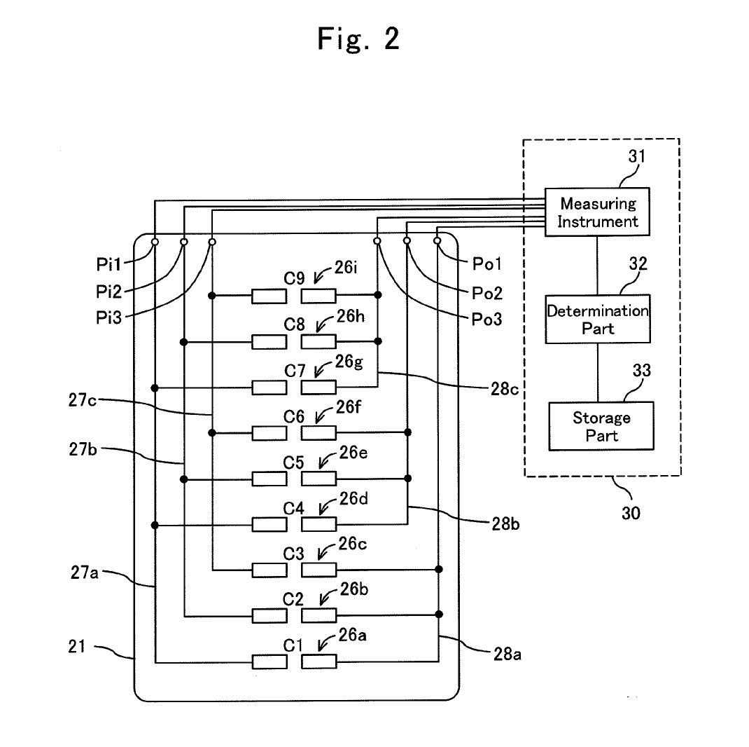

Next, the unit body 21 of the electrode unit 20 will be described in detail with reference to FIG. 2. The plurality of electrode pairs 26a to 26i are disposed at different positions in a height direction on a surface of a substrate of the unit body 21. Capacitances of the electrode pairs 26a to 26i are called C1 to C9, respectively, from bottom to top.

Wires 27a to 27c are formed so that any one of the wires 27a to 27c is electrically connected to one electrode of each electrode pair of the plurality of electrode pairs 26a to 26i (hereinafter referred to as voltage-applying wires). On the other hand, wires 28a to 28c are formed so that any one of the wires 27a to 27c is electrically connected to the other electrode of each electrode pair (hereinafter referred to as output wires).

The first voltage-applying wire 27a is connected to the electrode pairs 26a, 26d, 26g. The second voltage-applying wire 27b is connected to the electrode pairs 26b, 26e, 26h. The third voltage-applying wire is connected to the electrode pairs 26c, 26f, 26i. The first output wire 28a is connected to the electrode pairs 26a, 26b, 26c. The second output wire 28b is connected to the electrode pairs 26d, 26e, 26f. The third output wire is connected to the electrode pairs 26g, 26h, 26i.

Here, terminals connected to the voltage-applying wires 27a, 27b, 27c are called Pi1, Pi2, Pi3, respectively. Terminals connected to the output wires 28a, 28b, 28c are called Po1, Po2, Po3, respectively.

The detection circuit 30 comprises a measuring instrument 31, a storage part 33 and a determination part 32. The measuring instrument 31 is connected to the terminals Pi1, Pi2, Pi3 of the voltage-applying wires 27a, 27b, 27c and the terminals Po1, Po2, Po3 of the output wires 28a, 28b, 28c via electric cables. While one of the terminals Pi1, Pi2, and Pi3 is connected to a power supply side of the measuring instrument 31, one of the terminals Po1, Po2, Po3 is connected to an output side of the measuring instrument 31.

Then the measuring instrument 31 applies voltage Vi to an electrode pair as a measurement target of the plurality of electrode pairs 26a to 26i and measures output potential Vo of the electrode pair as the measurement target. For example, when voltage is applied to the electrode pair 26a as a measurement target, the voltage-applying wire 27a is connected to the power supply side and the output wire 28a is connected to the output side of the measuring instrument 31.

Here, the output potential Vo measured by the measuring instrument 31 is a capacitance equivalent value Cx. That is to say, the measuring instrument 31 can obtain respective capacitance equivalent values Cx1, Cx2, . . . Cx8, Cx9 of the plurality of electrode pairs 26a to 26i. It should be noted that the potential Vo has a linear relation with capacitance Cf between the electrode pair as the measurement target.

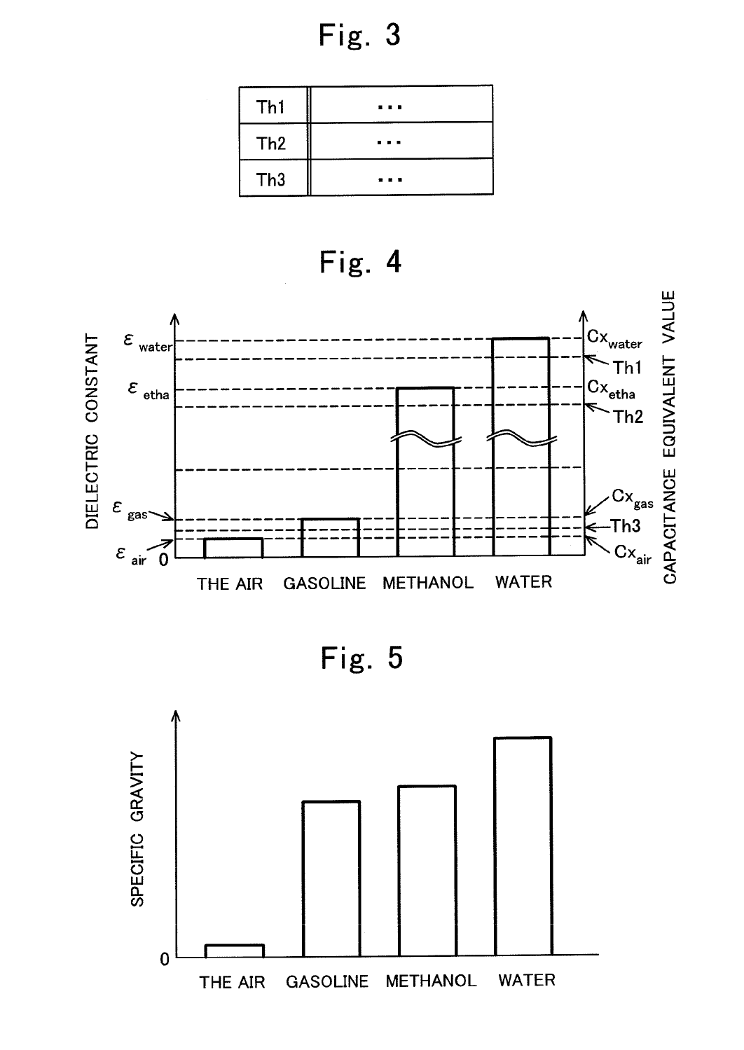

The storage part 33 stores liquid quality determination threshold values Th1, Th2, Th3, as shown in FIG. 3. The threshold value Th1 is a threshold value for determining whether liquid quality is water or not. The threshold value Th2 is a threshold value for determining whether liquid quality is methanol or not. The threshold value Th3 is a threshold value for determining whether liquid quality is gasoline or the air.

The determination part 32 determines the kind of fluid present at positions of the respective electrode pairs of the plurality of electrode pairs 26a to 26i based on the capacitance equivalent values Cx of the respective electrode pairs of the plurality of the electrode pairs 26a to 26i detected by the measuring instrument 31 and the liquid quality determination threshold values Th1 to Th3 stored in the storage part 33.

### 3. Description of Difference in Capacitance and Specific Gravity

The fuel tank 10 basically stores gasoline, but sometimes contains water and/or methanol. In such a case, the fuel tank 10 contains gasoline, water and/or methanol, not to mention the air.

A difference in dielectric constant between gasoline, water, methanol and the air will be discussed with reference to FIG. 4. The air has a dielectric constant ∈ₐᵢᵣ of about 1.0. Gasoline has a dielectric constant ∈_{gas} of about 2.0. Methanol has a dielectric constant ∈ₘₑₜₕₐ of about 33. Water has a dielectric constant ∈_{water} of about 80. That is to say, dielectric constant is greater in an order of the air, gasoline, and water.

Here, the storage part 33 (shown in FIG. 2) stores the liquid quality determination threshold values Th1 to Th3 as mentioned above. As shown along the right vertical axis of FIG. 4, capacitance equivalent values Cx of the air, gasoline, methanol, and water are Cxₐᵢᵣ, Cx_{gas}, Cxₘₑₜₕₐ, and Cx_{water}, respectively.

The threshold value Th1 for determining whether liquid quality is water or not is smaller than Cx_{water} and greater than Cxₘₑₜₕₐ. The threshold value Th2 for determining whether liquid quality is methanol or not is smaller than Cxₘₑₜₕₐ and greater than Cx_{gas}. The threshold value Th3 for determining whether liquid quality is gasoline or the air is smaller than Cx_{gas} and greater than Cxₐᵢᵣ. That is to say, the liquid quality determination threshold values Th1, Th2, Th3 are determined based on the capacitance equivalent values Cxₐᵢᵣ, Cx_{gas}, Cxₘₑₜₕₐ, Cx_{water} between one of the plurality of electrode pairs 26a to 26i in the presence of the air or the plurality of kinds of liquids.

Next, as shown in FIG. 5, specific gravity is greater in an order of the air, gasoline, methanol, and water. Therefore, when the air, gasoline, methanol, and water are contained in the fuel tank 10, water, gasoline, methanol and the air are stored in an order from the bottom of the fuel tank 10. In some cases, however, gasoline has a greater specific gravity than methanol. In this case, the order of gasoline and methanol is switched.

### 4. Process Performed by Determination Part

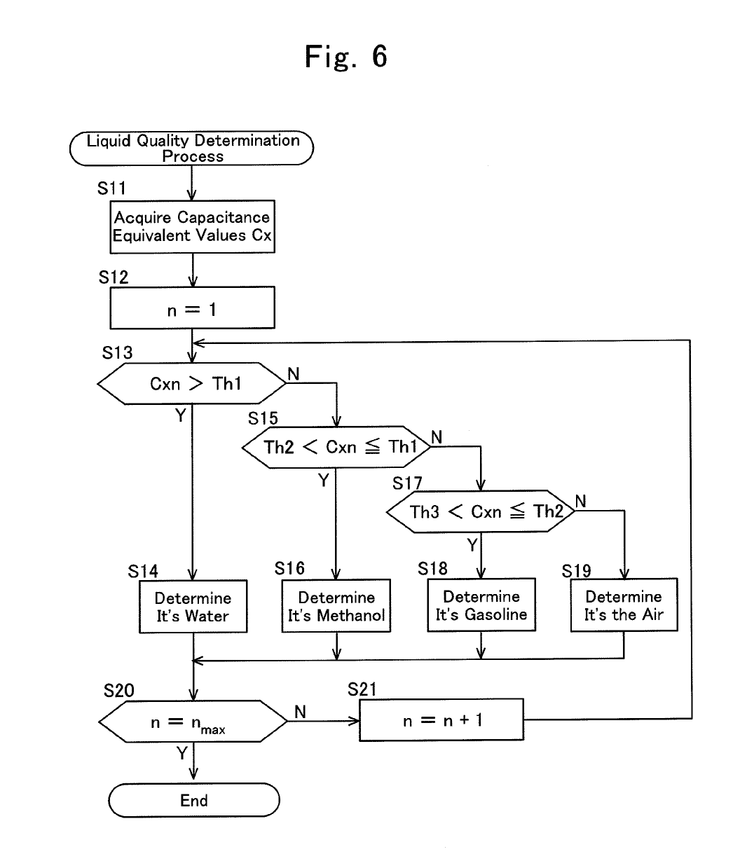

Next, a process performed by the determination part 32 shown in FIG. 2 will be described with reference to FIG. 6. The determination part 32 determines liquid quality of liquid present between the respective electrode pairs 26a to 26i by using the capacitance equivalent values Cx1, Cx2, . . . , Cx8, Cx9 obtained by the measuring instrument 31 and the liquid quality determination threshold values Th1 to Th3 stored in the storage part 33.

The determination part 32 acquires the respective capacitance equivalent values Cx1, Cx2, . . . , Cx8, Cx9 obtained by the measuring instrument 31 (S11). The acquired capacitance equivalent values Cx1 to Cx9 are values having a linear relation with the capacitances C1 to C9 between the respective electrode pairs 26a to 26i.

Next, a counter n is set to an initial value 1 (S12). Next, the determination part 32 determines whether a capacitance equivalent value Cxn corresponding to a nth electrode pair (for example, Cx1 corresponding to the first electrode pair 26a when n=1) is greater than the first threshold value Th1 or not (S13). When this condition is satisfied (S13: Y), the determination part 32 determines that the kind of fluid present at a position of this electrode pair is water (S14).

When the condition of S13 is not satisfied (S13: N), the determination part 32 determines whether the capacitance equivalent value Cxn corresponding to the nth electrode pair is equal to or smaller than the first threshold value Th1, and greater than the second threshold value Th2 or not (S15). When this condition is satisfied (S15: Y), the determination part 32 determines that the kind of fluid present at the position of this electrode pair is methanol (S16).

When the condition of S15 is not satisfied (S15: N), the determination part 32 determines whether the capacitance equivalent value Cxn corresponding to the nth electrode pair is equal to or smaller than the second threshold value Th2 and greater than the third threshold value Th3 or not (S17). When this condition is satisfied (S17: Y), the determination part 32 determines that the kind of fluid present at the position of this electrode pair is gasoline (S18). When this condition is not satisfied (S17: N), the determination part 32 determines that the kind of fluid present at the position of this electrode pair is the air (S19).

After the determination of S14, S16, S18, or S18, the determination part 32 determines whether the counter n is a maximum value n or not (S20), and when the counter n is not the maximum value nₘₐₓ, 1 is added to n (S21) and the steps are repeated from S13.

In this way, the determination part 32 can determine that the kind of fluid (liquid quality when fluid is a liquid) present at positions of the respective electrode pairs 26a to 26i. Therefore, height (liquid level) of each of water, gasoline, and methanol in the fuel tank 10 can be grasped.

### Example 2

In Example 1, liquid quality is determined by using the threshold values Th1, Th2 and Th3 which are common to all of the plurality of electrode pairs 26a to 26i. In contrast, in this example, liquid quality is determined by using threshold values Th1(n), Th2(n), Th3(n) which are different with each of the electrode pairs 26a to 26i.

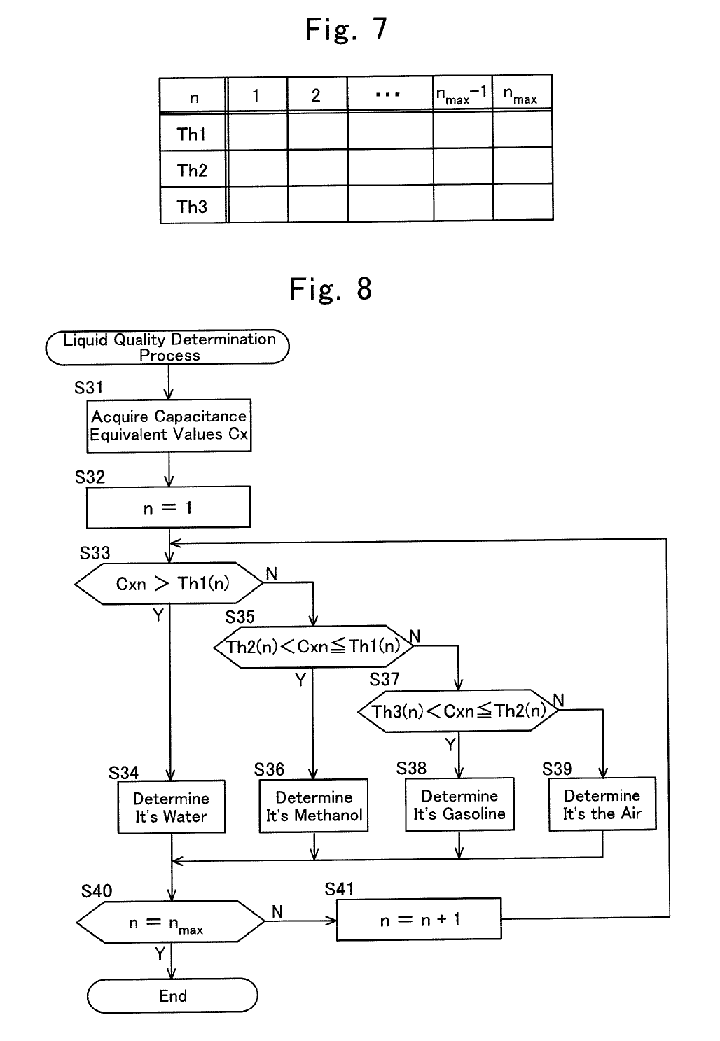

In this case, in this example, the storage part 33 stores threshold values Th1 to Th3 respectively corresponding to the kind of fluid for each of the plurality of electrode pairs 26a to 26i, as shown in FIG. 7. In FIG. 7, n is the number of capacitance (e.g., in a case of C1, n=1). That is to say, the storage part 33 stores threshold values Th1(1), Th2(1), Th3(1) for the electrode pair 26a (C1).

In this case, the determination part 32 executes a liquid quality determination process as shown in FIG. 8. The determination part 32 acquires respective capacitance equivalent values Cx1 to Cx9 obtained by the measuring instrument 31 (S31). Then the counter n is set to an initial value 1 (S32).

Then the determination part 32 determines whether a capacitance equivalent value Cxn corresponding to capacitance Cn between a nth electrode pair is greater than a first threshold value Th1(n) corresponding to the nth electrode pair or not (S33). When this condition is satisfied (S33: Y), the determination part 32 determines that the kind of fluid present at a position of this electrode pair is water (S34).

When the condition of S33 is not satisfied (S33: N), the determination part 32 determines whether the capacitance equivalent value Cxn of the nth electrode pair is equal to or smaller than the first threshold value Th1(n) corresponding to the nth electrode pair and greater than a second threshold value Th2(n) corresponding to the nth electrode pair or not (S35). When this condition is satisfied (S35: Y), the determination part 32 determines that the kind of fluid present at the position of this electrode pair is methanol (S36).

When the condition of S35 is not satisfied (S35: N), the determination part 32 determines whether the capacitance equivalent value Cxn of the nth electrode pair is equal to or smaller than the second threshold value Th2(n) corresponding to the nth electrode pair and greater than a third threshold value Th3(n) corresponding to the nth electrode pair or not (S37). When this condition is satisfied (S37: Y), the determination part 32 determines that the kind of fluid present at the position of this electrode pair is gasoline (S38). When this condition is not satisfied (S37: N), the determination part 32 determines that the kind of fluid present at the position of this electrode pair is the air (S39).

After the determination of S34, S36, S38, or S39, the determination part 32 determines whether the counter n is a maximum value nₘₐₓ or not (S40). When the counter n is not the maximum value nₘₐₓ, 1 is added to n (S41) and the steps are repeated from S33.

In this way, the determination part 32 can determine the kind of fluid (liquid quality when fluid is a liquid) present at a position of each of the plurality of electrode pairs 26a to 26i. Therefore, height (liquid level) of each of water, gasoline and methanol in the fuel tank 10 can be grasped.

In this way, the storage part 32 stores a plurality of liquid quality determination threshold values Th1 (1), . . . Th1(n), Th2(1), . . . Th2(n), Th3(1), . . . Th3(n) (n is put in parentheses for distinction) corresponding to the kind of fluid for the respective electrode pairs 1 to n of the plurality of electrode pairs 26a to 26i.

The determination part 32 extracts a plurality of liquid quality determination threshold values Th1(k), Th2(k), Th3(k) corresponding to the electrode pair k among the plurality of liquid quality determination threshold values Th1(1), . . . Th1(n), Th2(1), . . . Th2(n), Th3(1), . . . Th3(n), the determination part 32 compares the extracted plurality of liquid quality determination threshold values Th1(k) Th2(k), Th3(k) and a value Cxk equivalent to capacitance between this electrode pair k, and the determination part 32 determines liquid quality of a liquid present at a position of an electrode pair k as a measurement target based on the comparison result.

Even if there is the same kind of liquid, a measured capacitance equivalent value Cxn sometimes varies with a difference in position between the electrode pairs 26a to 26i. Therefore, the storage part 33 stores different liquid quality determination threshold values Th1(1), . . . Th1(n), Th2(1), . . . Th2(n), Th3(1), . . . Th3(n) for the respective electrode pairs 1 to n. Then by comparing the liquid quality determination threshold values Th1(k), Th2(k), Th3(k) corresponding to the electrode pair k as the determination target with the capacitance equivalent value Cxk, the determination part 32 can reliably determine liquid quality of a liquid present at the position of the electrode pair k.

### Example 3

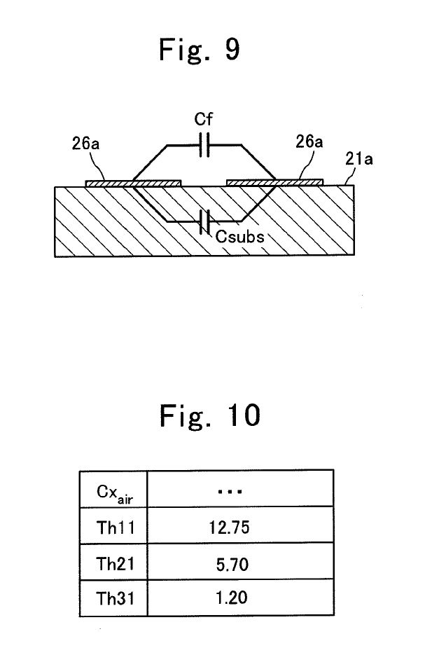

The unit body 21 of the electrode unit 20 is formed by attaching the plurality of electrode pairs 26a to 26i on a surface of a substrate 21a, as shown in FIG. 9. In this case, capacitance C between each electrode pair of the plurality of electrode pairs 26a to 26i is a sum of capacitance Cf of a fluid present between one-side surfaces (upper surfaces in FIG. 9) of that electrode pair and capacitance C_{subs} of the substrate 21a present between the-other-side surfaces (lower surfaces in FIG. 9) of that electrode pair as shown in Formula (1).

[Math. 1]

C=Cf+C_{subs} (1)

Therefore, dielectric constant of the substrate 21a may affect capacitance equivalent values Cx obtained by the measuring instrument. When fluid present at a position of that electrode pair is the air, capacitance C1ₐᵢᵣ is expressed by Formula (2). When liquid present at the position of that electrode pair is water, capacitance C1_{water} is expressed by Formula (3). When liquid present at the position of that electrode pair is methanol, capacitance C1ₘₑₜₕₐ is expressed by Formula (4). When liquid present at the position of that electrode pair is gasoline, capacitance C1_{gas} is expressed by Formula (5). In the formulas, ∈ is a dielectric constant and Ka is a constant.

[Math. 2]

C1ₐᵢᵣ==Cₐᵢᵣ+C_{subs}=(∈ₐᵢᵣ+∈_{subs})×Ka (2)

[Math. 3]

C1_{water}=C_{water}+C_{subs}=(∈_{water}+∈_{subs})×Ka (3)

[Math. 4]

C1ₘₑₜₕₐ=Cₘₑₜₕₐ+C_{subs}=(∈ₘₑₜₕₐ+∈_{subs})×Ka (4)

[Math. 5]

C1_{gas}=C_{gas}+C_{subs}=(∈ₐᵢᵣ+∈_{subs})×Ka (5)

At this time, a capacitance equivalent value Cx obtained by the measuring instrument 31 is a value shown in Formula (6).

[Math. 6]

Cx=(Cf+C_{subs})×Kb (6)

However, capacitance C_{subs} affected by the substrate 21a cannot be obtained. Therefore, a calculated value dCx for comparison is used instead of the capacitance equivalent value Cx. As shown in Formula (7), the calculated value dCx for comparison is obtained by dividing the detected capacitance equivalent value Cx with an air reference value Cxₐᵢᵣ, which is a value equivalent to capacitance between that electrode pair in the presence of the air. The air reference value Cxₐᵢᵣ is expressed by Formula (8).

$$\begin{matrix}[ Math . 7 ] & \\ dCx = \frac{Cx}{{Cx}_{air}} & ( 7 ) \\ [ Math . 8 ] & \\ \begin{matrix}{Cx}_{air} = ( {C}_{air} + {C}_{subs} ) \times Kb \\ = C {1}_{air} \times Kb \\ = ( {ɛ}_{air} + {ɛ}_{subs} ) \times Ka \times Kb\end{matrix} & ( 8 )\end{matrix}$$

Use of the calculated value dCx for comparison shown by Formula (7) enables to obtain a difference in capacitance equivalent value Cx, even if capacitance C_{subs} of the substrate 21a in itself cannot be grasped. Threshold values Th11, Th21, Th31 used in this case will be discussed hereinafter. Here, it is assumed that respective fluids have dielectric constants shown in Formula (9), for instance.

[Math. 9]

∈ₐᵢᵣ=1

∈_{gas}=2

∈ₘₑₜₕₐ=33

∈_{water}=80

∈_{subs}=5 (9)

In this case, the first threshold value Th11 is a threshold value for determining whether liquid quality is water or not and expressed by Formula (10). That is to say, the first threshold value Th11 is defined as a value obtained by dividing a value Cx_{water} equivalent to capacitance between an electrode pair in the presence of water (a liquid reference value for water) with the air reference value Cxₐᵢᵣ and multiplying the quotient by 0.9. The multiplier coefficient 0.9 can be suitably changed. Ka and Kb are coefficients. In this case, the first threshold value Th11 is 12.75.

$$\begin{matrix}[ Math . 10 ] & \\ \begin{matrix}Th 11 = ( \frac{{Cx}_{water}}{{Cx}_{air}} ) \times 0.9 \\ = ( \frac{( 80 + 5 ) \times Ka \times Kb}{( 1 + 5 ) \times Ka \times Kb} ) \times 0.9 \approx 12.75\end{matrix} & ( 10 )\end{matrix}$$

The second threshold value Th21 is a threshold value for determining whether liquid quality is methanol or not and expressed by Formula (11). That is to say, the second threshold value Th12 is defined as a value obtained by dividing a value Cxₘₑₜₕₐ equivalent to capacitance between the electrode pair in the presence of methanol (a liquid reference value for methanol) with the air reference value Cxₐᵢᵣ and multiplying the quotient by 0.9. In this case, the second threshold value Th21 is 5.70.

$$\begin{matrix}[ Math . 11 ] & \\ \begin{matrix}Th 21 = ( \frac{{Cx}_{metha}}{{Cx}_{air }} ) \times 0.9 \\ = ( \frac{( 33 + 5 ) \times Ka \times Kb}{( 1 + 5 ) \times Ka \times Kb} ) \times 0.9 \approx 5.70\end{matrix} & ( 11 )\end{matrix}$$

The third threshold value Th31 is a threshold value for determining whether liquid quality is gasoline or the air and expressed by Formula (12). That is to say, the third threshold value Th13 is defined as a value obtained by dividing a value Cx_{gas} equivalent to capacitance between the electrode pair in the presence of gasoline (a liquid reference value for gasoline) with the air reference value Cxₐᵢᵣ and multiplying the quotient by 0.9. In this case, the third threshold value Th31 is 1.20.

$$\begin{matrix}[ Math . 12 ] & \\ \begin{matrix}Th 31 = ( \frac{{Cx}_{gas}}{{Cx}_{air}} ) \times 0.9 \\ = ( \frac{( 2 + 5 ) \times Ka \times Kb}{( 1 + 5 ) \times Ka \times Kb} ) \times 0.9 \approx 1.20\end{matrix} & ( 12 )\end{matrix}$$

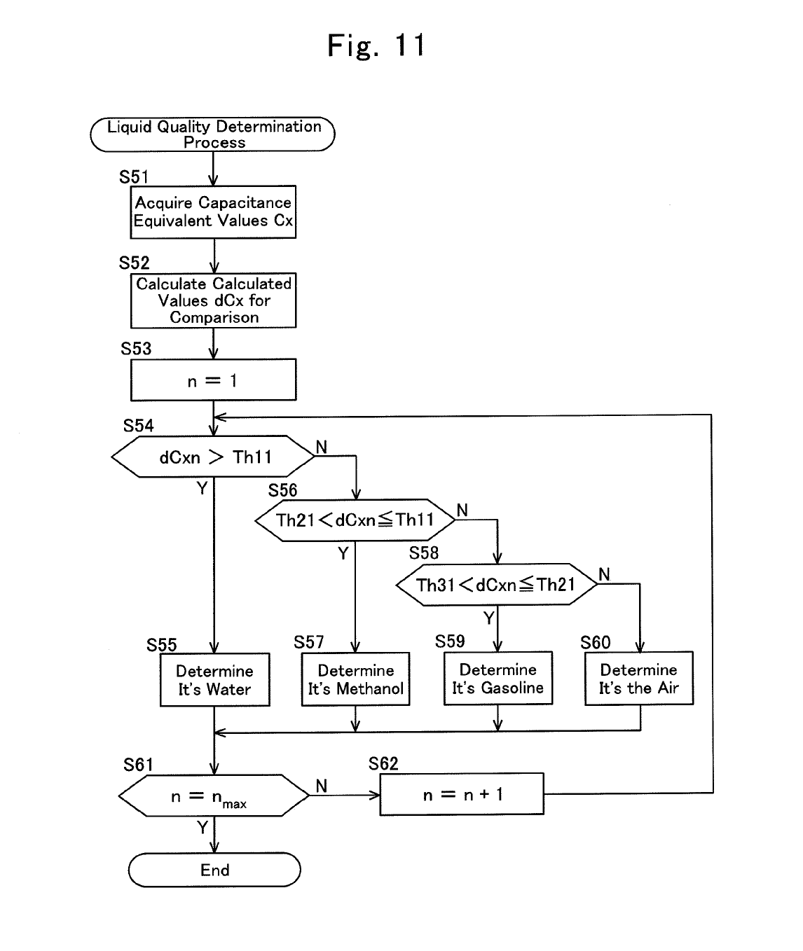

Accordingly, the storage part 33 stores the air reference value Cxₐᵢᵣ and the liquid quality determination threshold values Th11, Th21, and Th31 as shown in FIG. 10. A process performed by the determination part 32 in this case will be discussed with reference to FIG. 11.

The determination part 32 acquires respective capacitance equivalent values Cx1, Cx2, . . . Cx8, Cx9 obtained by the measuring instrument 31 (S51). Then the determination part 32 calculates calculated values dCx for comparison by using Formula (7) (S52). At this time, the air reference value Cxₐᵢᵣ used is a value stored in the storage part 33 beforehand. Next, the counter n is set to an initial value 1 (S53).

Then the determination part 32 determines whether a calculated value dCxn for comparison obtained by dividing a capacitance equivalent value Cxn corresponding to a nth electrode pair (a liquid reference value) with the air reference value Cxₐᵢᵣ is greater than the first threshold value Th11 or not (S54). When this condition is satisfied (S54: Y), the determination part 32 determines that the kind of fluid present at the position of that electrode pair is water (S55).

When the condition of S54 is not satisfied (S54: N), the determination part 32 determines whether the nth calculated value dCxn for comparison is equal to or smaller than the first threshold value Th11 and greater than the second threshold value Th21 or not (S56). When this condition is satisfied (S56: Y), the determination part 32 determines that the kind of fluid present at the position of that electrode pair is methanol (S57).

When the condition of S56 is not satisfied (S56: N), the determination part 32 determines whether the nth calculated value dCxn for comparison is equal to or smaller than the second threshold value Th21 and greater than the third threshold value Th31 or not (S58). When this condition is satisfied (S58: Y), the determination part 32 determines that the kind of fluid present at the position of that electrode pair is gasoline (S59). When this condition is not satisfied (S58: N), the determination part 32 determines that the kind of fluid present at the position of the electrode pair is the air (S60).

After the determination of S55, S57, S59 or S60, the determination part 32 determines whether the counter n is a maximum value nₘₐₓ or not (S61). When the counter n is not the maximum value nₘₐₓ, 1 is added to n (S62) and the steps are repeated from S54.

In this way, the determination part 32 can determine the kind of fluid (liquid quality when fluid is a liquid) present at a position of each of the plurality of electrode pairs 26a to 26i. Especially when the capacitance equivalent values Cxn are affected by the substrate 21a, the effect of the substrate 21a can be reduced by determination using the calculated values dCxn for comparison. Therefore, height (liquid level) of each of water, gasoline, methanol and water in the fuel tank 10 can be reliably grasped.

### Example 4

In Example 3, liquid quality is determined by using the threshold values Th11, Th21, Th31 which are common to all the plurality of electrode pairs 26a to 26i. In contrast, in this example, liquid quality is determined by using threshold values Th11(n), Th21(n), Th31(n) which are different with each of the plurality of electrode pairs 26a to 26i.

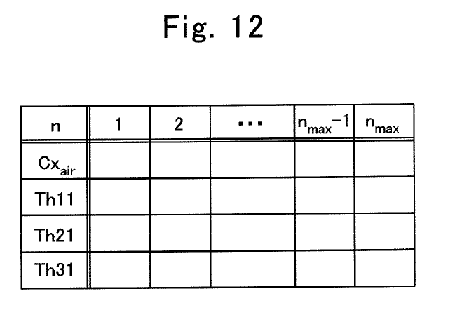

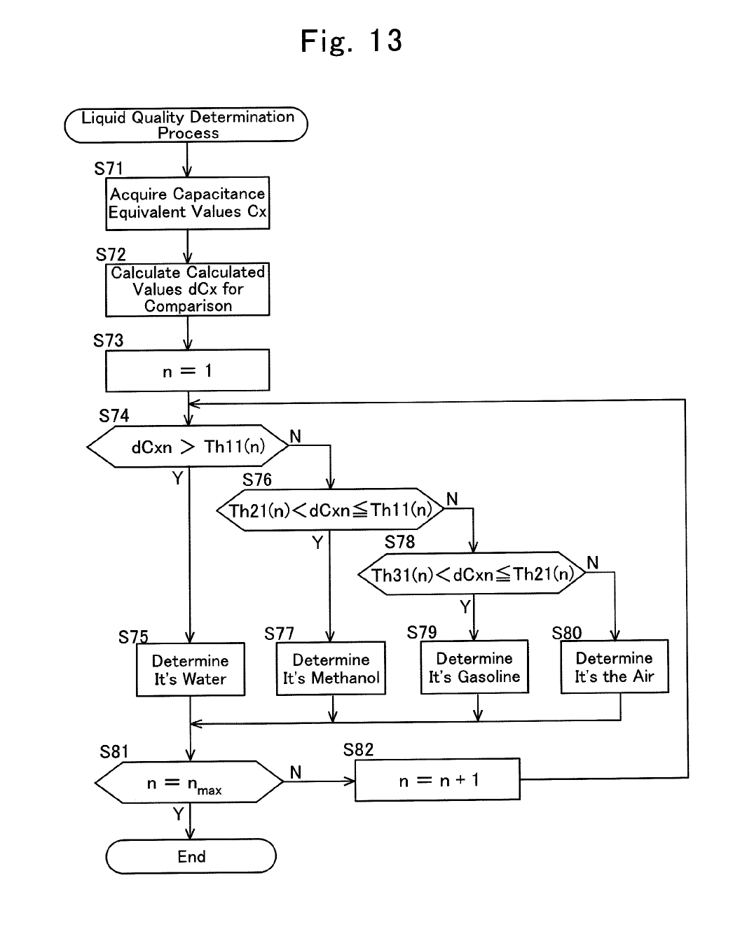

In this case, the storage part 33 stores threshold values Th11 to Th31 corresponding to the kind of fluid for each of the plurality of electrode pairs 26a to 26i, as shown in FIG. 12. The determination part 32 executes a liquid quality determination process as shown in FIG. 13. Here, a difference between Example 1 and Example 2 is substantially the same as that between Example 3 and this example. Therefore, a detailed description will be omitted here.

### Example 5

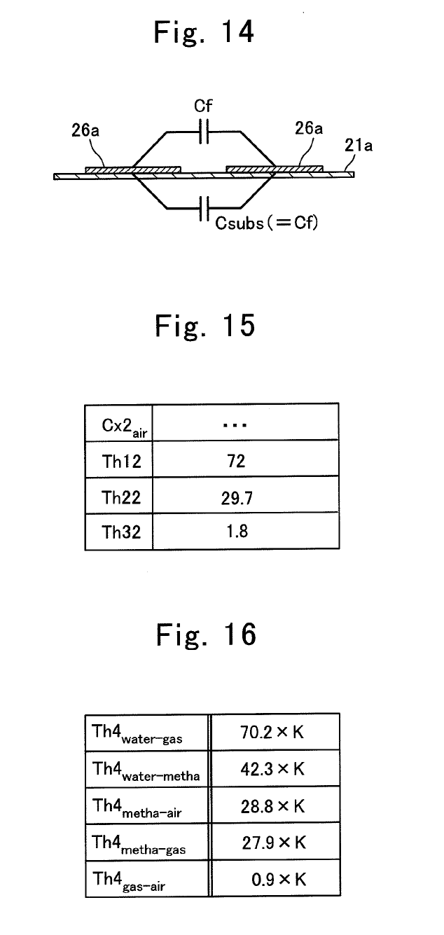

In Example 3, a description is given about a case where the substrate 21a has a great thickness and measured capacitance equivalent values Cx are greatly affected by the dielectric constant of the substrate 21a. In this example, a description will be given about a case where the substrate 21a has a small thickness as shown in FIG. 14 and capacitance equivalent values Cx are hardly affected by the dielectric constant of the substrate 21a.

In this case, the measured capacitance equivalent values Cx are more affected by a fluid present at a rear side of the substrate 21a than by the dielectric constant of the substrate 21a. At this time, as shown in Formula (13), capacitance C between each electrode pair of the plurality of electrode pairs 26a to 26i is a sum of capacitance Cf of a fluid present between one-side surfaces (upper surfaces in FIG. 9) of that electrode pair and capacitance C_{subs} of the substrate 21a present on the-other-side surfaces (lower surfaces in FIG. 9) of that electrode pair. Here, it is assumed that the capacitance C_{subs} is the same as capacitance Cf of a fluid present on the rear side of the substrate 21a. Accordingly, the capacitance C is as shown in Formula (13).

[Math. 13]

C=Cf+C_{subs}=2×Cf (13)

Accordingly, when fluid present at a position of that electrode pair is the air, capacitance C2ₐᵢᵣ is expressed by Formula (14). When the liquid present at the position of that electrode pair is water, capacitance C2_{water} is expressed by Formula (15). When liquid present at the position of that electrode pair is methanol, capacitance C2ₘₑₜₕₐ is expressed by Formula (16). When the liquid present at the position of that electrode pair is gasoline, capacitance C2_{gas} is expressed by Formula (17). In the formulas, F is a dielectric constant and Ka is a constant.

[Math. 14]

C2ₐᵢᵣ=2×Cₐᵢᵣ=2×∈ₐᵢᵣ×Ka (14)

[Math. 15]

C2_{water}=2×C_{water}=2×∈_{water}×Ka (15)

[Math. 16]

C2ₘₑₜₕₐ=2×Cₘₑₜₕₐ=2×∈ₘₑₜₕₐ×Ka (16)

[Math. 17]

C2_{gas}=2×C_{gas}=2×∈_{gas}×Ka (17)

At this time, capacitance equivalent values Cx obtained by the measuring instrument 31 are values shown in Formula (18). In the formulas, Kb is a constant.

[Math. 18]

Cx=2×Cf×Kb (18)

In this example, the capacitance equivalent values Cx are hardly affected by the substrate 21a but affected by fluid present on the rear side of the substrate 21a. This means that there are substantially two electrode pairs. In this way, because the electrode pairs are attached to the substrate 21a, capacitance cannot be determined only from capacitance of fluid present therebetween. Therefore, in this case, too, liquid quality is determined using calculated values dCx for comparison expressed by Formula (19), in a similar way to that of Example 3. Note that an air reference value Cx2ₐᵢᵣ is expressed by Formula (20).

$$\begin{matrix}[ Math . 19 ] & \\ dCx = \frac{Cx}{{Cx}_{air}} & ( 19 ) \\ [ Math . 20 ] & \\ \begin{matrix}Cx {2}_{air} = 2 \times {C}_{air} \times Kb \\ = C {2}_{air} \times Kb \\ = 2 \times {ɛ}_{air} \times Ka \times Kb\end{matrix} & ( 20 )\end{matrix}$$

In this case, threshold values Th12, Th22, Th32 are expressed by Formulas (21), (22), and (23), respectively. The first threshold value Th12 is 72. The second threshold value Th22 is 29.7. The third threshold value Th32 is 1.8.

$$\begin{matrix}[ Math . 21 ] & \\ \begin{matrix}Th 12 = ( \frac{Cx {2}_{water}}{Cx {2}_{air}} ) \times 0.9 \\ = ( \frac{( 80 + 80 ) \times Ka \times Kb}{( 1 + 1 ) \times Ka \times Kb} ) \times 0.9 \approx 72\end{matrix} & ( 21 ) \\ [ Math . 22 ] & \\ \begin{matrix}Th 22 = ( \frac{Cx {2}_{metha}}{Cx {2}_{air}} ) \times 0.9 \\ = ( \frac{( 33 + 33 ) \times Ka \times Kb}{( 1 + 1 ) \times Ka \times Kb} ) \times 0.9 \approx 29.7\end{matrix} & ( 22 ) \\ [ Math . 23 ] & \\ \begin{matrix}Th 32 = ( \frac{Cx {2}_{gas}}{Cx {2}_{air}} ) \times 0.9 \\ = ( \frac{( 2 + 2 ) \times Ka \times Kb}{( 1 + 1 ) \times Ka \times Kb} ) \times 0.9 \approx 1.8\end{matrix} & ( 23 )\end{matrix}$$

Accordingly, the storage part 33 stores the air reference value Cx2ₐᵢᵣ and the liquid quality determination threshold values Th12, Th22, and Th32 as shown in FIG. 15. A liquid quality determination process performed by the determination part 32 is similar to that of Example 3.

### Example 6

In the above examples, the determination part 32 determines the kind of fluid present at each electrode pair by directly comparing a value Cx equivalent to capacitance between the electrode pair and each of the threshold values. In this example, the determination part 32 grasps where a boundary surface of which fluid is present by determining whether a boundary surface of fluids is present between selected two electrode pairs or not.

Specifically, the determination part 32 directly compares differences ΔCx (difference values for comparison) among a capacitance equivalent value Cx of an electrode pair in the presence of the air or the plurality of liquids with boundary surface determination threshold values Th4 corresponding to those differences.

The difference value LC is a difference between capacitance equivalent values Cx(up) and Cx(down) of two height-different electrode pairs as shown by Formula (24). Here, the two height-different electrode pairs can be two electrode pairs adjacent in a height direction to each other or two electrode pairs sandwiching one or more electrode pairs therebetween.

[Math. 24]

ΔCx=Cx(up)−Cx(down) (24)

As shown in FIG. 16, the storage part 33 stores boundary surface determination threshold values Th4_{water-gas}, Th4_{water-menta}, Th4ₘₑₜₕₐ₋ₐᵢᵣ and Th4_{metha-gas}. Using Formulas (2) to (6) and (8), the boundary surface determination threshold values Th4_{water-gas}, Th4_{water-metha}, Th4ₘₑₜₕₐ₋ₐᵢᵣ and Th4_{metha-gas} are respectively expressed by Formulas (25), (26), (27), (28), and (29). In the formulas, K is a coefficient. The boundary surface determination threshold values Th4_{water-gas}, Th4_{water-metha}, Th4ₘₑₜₕₐ₋ₐᵢᵣ and Th4_{metha-gas} can be obtained by actually measuring capacitance equivalent values Cx of the respective fluids beforehand.

[Math. 25]

Th4_{water-gas}=(Cx_{water}−Cx_{gas})×0.9=70.2×K (25)

[Math. 26]

Th4_{water-metha}=(Cx_{water}−Cxₘₑₜₕₐ)×0.9=42.3×K (26)

[Math. 27]

Th4ₘₑₜₕₐ₋ₐᵢᵣ=(Cxₘₑₜₕₐ−Cxₐᵢᵣ)×0.9=28.8×K (27)

[Math. 28]

Th4_{metha-gas}=(Cxₘₑₜₕₐ−Cx_{gas})×0.9=27.9×K (28)

[Math. 29]

Th4_{gas-air}=(Cx_{gas}−Cxₐᵢᵣ)×0.9=0.9×K (29)

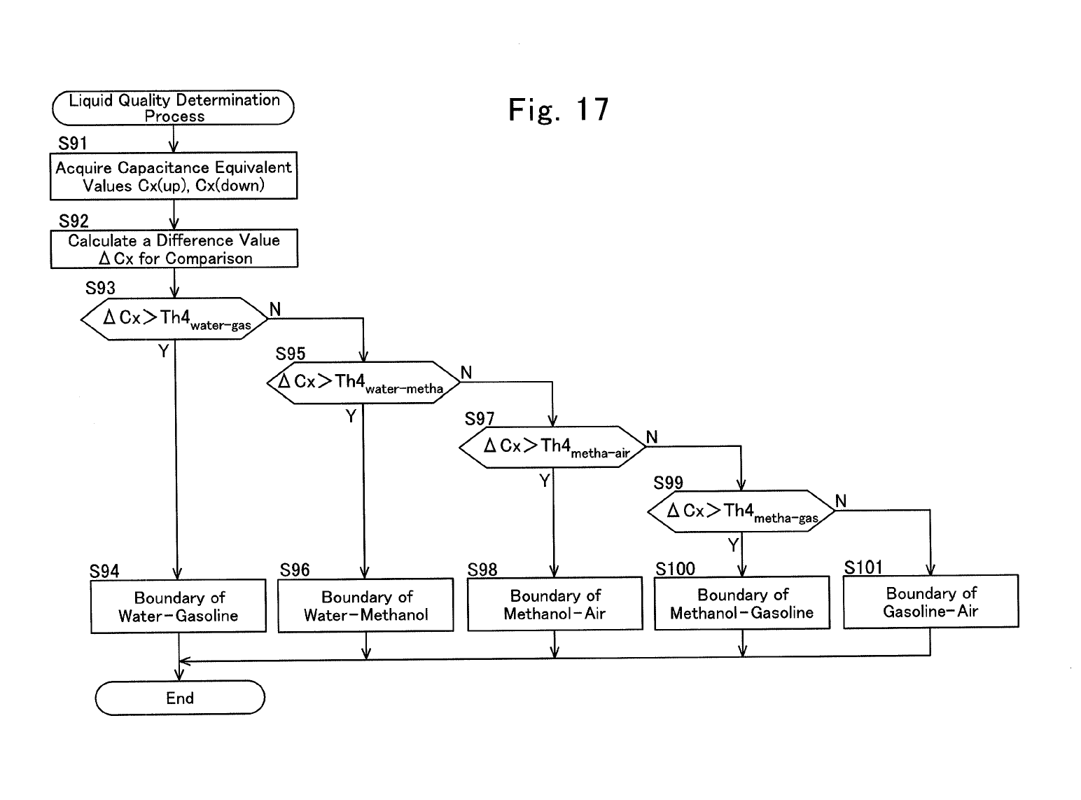

A determination process performed by the determination part 32 in this case will be discussed with reference to FIG. 17. First, the determination part 32 acquires capacitance equivalent values Cx(up) and Cx(down) of two height-different electrode pairs (S91). For example, preferably determination is performed in an order from a lowest electrode pair 26a to top. Then a difference value ΔCx for comparison is calculated using Formula (24) (S92).

Then the determination part 32 determines whether the difference value ΔCx for comparison is greater than the threshold value Th4_{water-gas} for determining a boundary surface between water and gas or not (S93). When this condition is satisfied (S93: Y), the determination part 32 determines that a boundary surface between water and gasoline is present in a gap in a height direction between those two electrode pairs (S94).

When the condition of S93 is not satisfied (S93: N), the determination part 32 determines whether the difference value ΔCx for comparison is greater than the threshold value Th4_{water-meta} for determining a boundary surface between water and methanol or not (S95). When this condition is satisfied (S95: Y), the determination part 32 determines that a boundary surface between water and methanol is present in the gap in the height direction between those two electrode pairs (S96).

When the condition of S95 is not satisfied (S95: N), the determination part 32 determines whether the difference value ΔCx for comparison is greater than the threshold value Th4ₘₑₜₕₐ₋ₐᵢᵣ for determining a boundary surface between methanol and the air or not (S97). When this condition is satisfied (S97: Y), the determination part 32 determines that a boundary surface between methanol and the air is present in the gap in the height direction between those two electrode pairs (S98).

When the condition of S97 is not satisfied (S97: N), the determination part 32 determines whether the difference value ΔCx for comparison is greater than the threshold value Th4_{metha-gas} for determining a boundary surface between methanol and gasoline or not (S99). When this condition is satisfied (S99: Y), the determination part 32 determines that a boundary surface between methanol and gasoline is present in the gap in the height direction between those two electrode pairs (S100). When this condition is not satisfied (S99: N), the determination part 32 determines that a boundary surface between gasoline and the air is present in the gap in the height direction between those two electrode pairs (S101).

In this way, the determination part 32 can determine that different fluids are present in the gap in the height direction between those two electrode pairs by comparing the difference value ΔCx for comparison and each of the boundary surface determination threshold values Th4_{water-gas}, Th4_{water-metha}, Th4ₘₑₜₕₐ₋ₐᵢᵣ, and Th4_{metha-gas}. That is to say, liquid level of the respective liquids can be determined by grasping boundary surfaces of the respective liquids.

### Example 7

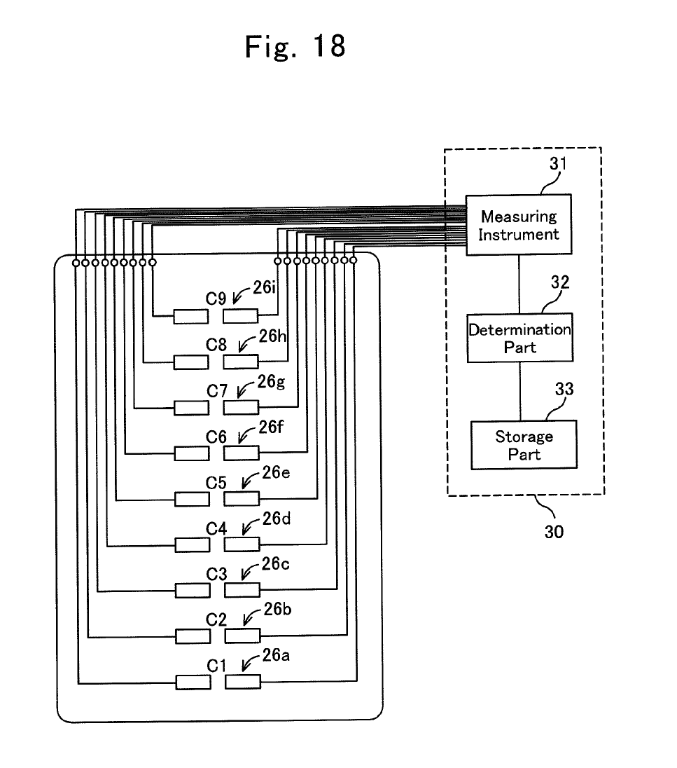

As shown in FIG. 2, the wires connected to the plurality of electrode pairs 26a to 26i are partly shared in the unit body 21. In contrast, as shown in FIG. 18, wires can be individually provided for the plurality of electrode pairs 26a to 26i.

### Example 8

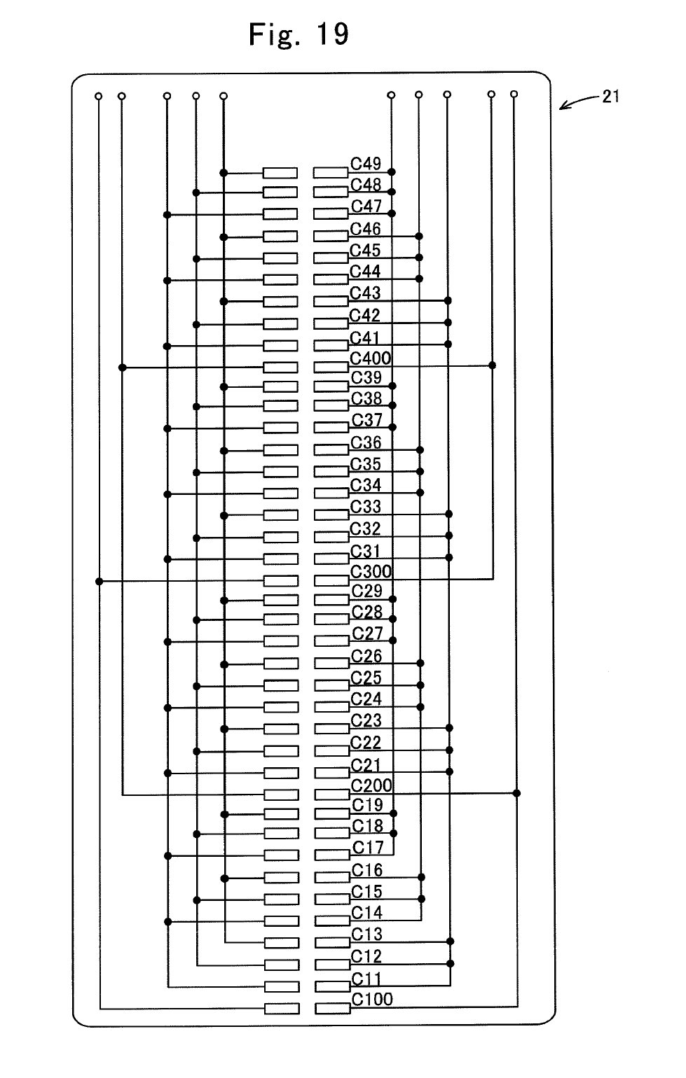

Next, as shown in FIG. 19, the unit body 21 comprises a plurality of first electrode pair units C11 to C19, C21 to C29, C31 to C39, C41 to C49 and second electrode pairs C100, C200, C300 and C400.

Each of the first electrode pair units C11 to C19, C21 to C29, C31 to C39, C41 to C49 has the same structure as the plurality of electrode pairs C1 to C9 in Example 1 shown in FIG. 2. That is to say, a plurality of first electrode pairs disposed at different positions in a height direction in the tank constitute each of the first electrode pair units C11 to C19, C21 to C29, C31 to C39 and C41 to C40. The first electrode pair unit C11 to C19 is located at a lowest position and the first electrode pair units C11 to C19, C21 to C29, C31 to C39, C41 to C49 are disposed at different positions in the height direction from bottom to top.

Furthermore, in the first electrode pairs constituting the respective first electrode pair units, first electrode pairs with the same units digit are connected by the same wiring. For example, C11, C21, C31 and C41 are connected by the same wiring, and C12, C22, C32, and C42 are connected by the same wiring. When a plurality of first electrode pairs are connected by the same wiring, capacitance equivalent values Cx of all the first electrode pairs connected by the same wiring are measured.

Therefore, in order to distinguish each of the first electrode pair units, second electrode pairs 100 to 400 are disposed so as to correspond to the first electrode pair units, respectively. Specifically, the second electrode pair 100 is disposed just below the first electrode pair unit C11 to C19. The second electrode pair 200 is disposed above the first electrode pair unit C11 to C19 and just below the first electrode unit C21 to C29. In this way, the second electrode pairs 100 to 400 are disposed around positions of the first electrode pair units, respectively.

In this case, the storage part 33 stores threshold values Th100, Th200, Th300, and Th400 respectively corresponding to the first electrode pair units C11 to C19, C21 to C29, C31 to C39, and C41 to C49. Moreover, the storage part 33 stores a plurality of second determination threshold values for determination using the second electrode pairs 100 to 400. Here, each of the threshold values Th100, Th200, Th300, and Th400 is a collective term for a plurality of threshold values corresponding to liquid quality as mentioned in the above examples.

The threshold values Th100 to Th400 are different from each other. For example, the threshold value Th100 to be compared with capacitance equivalent values of or the first electrode pair unit C11 to C19 located at the lowest position is a minimum value, and a threshold value for a first electrode pair unit at a higher position is a greater value.

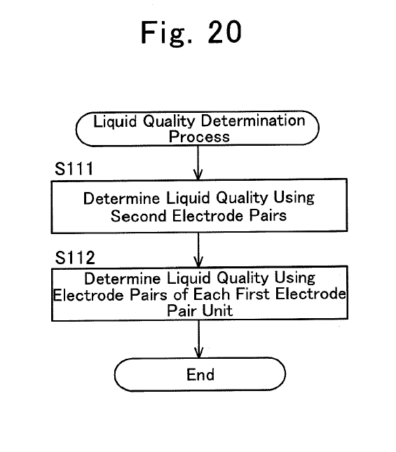

A determination process is performed by the determination part 32 as shown in FIG. 20. First, the determination part 32 compares values Cx equivalent to capacitance between the respective second electrode pairs 100 to 400 with each of the plurality of second determination threshold values. That is to say, the determination part 32 determines liquid quality at positions of the respective second electrode pairs 100 to 400 (S111).

Then the determination part 32 compares capacitance equivalent values of the first electrode pairs constituting each of the first electrode pair units with the threshold values Th100, Th200, Th300 or Th400 (S112). At this time, the determination part 32 compares capacitance equivalent values Cx obtained by the first electrode pairs C11 to C19 with a plurality of threshold values of the threshold value Th100 corresponding to the kind of liquid. The determination part 32 executes similar comparisons for the rest.

In this way, the determination part 32 can determine which kind of liquid is present at a position of which first electrode pair of the plurality of first electrode pairs connected by the same wiring (e.g., C11, C21, C31, C41) by carrying out measurement using the second electrode pairs 100 to 400 and by using different threshold values for each of the first electrode pair units C11 to C19, C21 to C29, C31 to C39 and C41 to C49, respectively.

Furthermore, the electrode pairs of one first electrode unit C11 to C19 are connected to any one of the first electrode pairs of the other first electrode pair units C21 to C29, C31 to C39, and C41 to C49 by the same wiring. Therefore, the volume of wiring can be reduced. However, because different electrode pairs are connected by the same wiring, the determination part 32 cannot determine between which of these different electrode pairs a certain liquid is present. As mentioned above, use of the second electrode pairs C100 to C400 enables the determination part 32 to determine which unit of the plurality of the first electrode pair units should be selected for comparison.

What is claimed is:

1. A capacitive liquid level detection device, comprising
a plurality of electrode pairs disposed at different positions in a height direction in a tank for storing liquid;
a measuring instrument for acquiring values equivalent to capacitance between respective electrode pairs of the plurality of electrode pairs;
a storage part for storing a plurality of threshold values determined based on values equivalent to capacitance between one of the plurality of electrode pairs in the presence of the air or a plurality of kinds of liquids; and
a determination part comparing the values equivalent to capacitance between the respective electrode pairs of the plurality of electrode pairs with each of the plurality of threshold values, and the determination part determines for determining liquid level corresponding to liquid quality based on the comparison result.

2. The capacitive liquid level detection device according to claim 1, wherein
the plurality of threshold values stored in the storage part are a plurality of liquid quality determination threshold values corresponding to the kind of liquid; and
the determination part compares the values equivalent to capacitance between the respective electrode pairs with each of the plurality of liquid quality determination threshold values, and the determination part determines liquid quality of liquid present at positions of the respective electrode pairs of the plurality of electrode pairs based on the comparison result.

3. The capacitive liquid level detection device according to claim 2, wherein
when a value equivalent to capacitance between the one of the plurality of electrode pairs in the presence of the air is defined as an air reference value, and
values equivalent to capacitance between the one of the plurality of electrode pairs in the presence of the plurality of kinds of liquids are respectively defined as liquid reference values,
the plurality of liquid quality determination threshold values are respectively determined based on values obtained by dividing the liquid reference values with the air reference value, and
the determination part calculates values by dividing the capacitance equivalent values acquired by the measuring instrument with the air reference value, the determination part compares the calculated values with each of the plurality of liquid quality determination threshold values, the determination part determines liquid level corresponding to liquid quality based on the comparison result.

4. The capacitive liquid level detection device according to claim 2, wherein
the storage part stores the plurality of liquid quality determination threshold values corresponding to the kind of liquid for each of the plurality of electrode pairs; and
the determination part extracts a plurality of liquid quality determination threshold values corresponding to the electrode pair as the determination target among the plurality of liquid quality determination threshold values, the determination part compares the extracted plurality of liquid quality determination threshold values with a value equivalent to capacitance between the electrode pair as the determination target, and the determination part determines liquid quality of a liquid present at a position of an electrode pair as a determination target of the plurality of electrode pairs based on the comparison result.

5. The capacitive liquid level detection device according to claim 1, wherein
the plurality of threshold values stored in the storage part are a plurality of boundary surface determination threshold values corresponding to differences in values equivalent to capacitance between the one of the plurality of electrode pairs in the presence of the air or and the plurality of kinds of liquids; and
the determination part compares a difference between a value equivalent to capacitance between one electrode pair of the two different electrode pairs and a value equivalent to capacitance between the other pair with each of the plurality of boundary surface determination threshold values, and the determination part determines that different fluids are present in a gap in a height direction between two different electrode pairs of the plurality of electrode pairs based on the comparison result.

6. The capacitive liquid level detection device according to claim 1, wherein
the capacitive liquid level detection device comprises
a plurality of first electrode pair units disposed at different positions in the height direction in the tank, each of the plurality of first electrode pair units comprising a plurality of first electrode pairs disposed at different positions in the height direction, and each of the plurality of first electrode pairs in one of the plurality of first electrode pair units and any one of the plurality of first electrode pairs in another of the plurality of first electrode pair units being connected by the same wiring, and
a plurality of second electrode pairs respectively disposed around positions of the plurality of first electrode pair units;
the storage part stores the plurality of threshold values corresponding to the respective units of the plurality of first electrode pair units, and the storage part stores a plurality of second determination threshold values for determination using the plurality of second electrode pairs; and
the determination part compares values equivalent to capacitance between the respective electrode pairs of the plurality of second electrode pairs with each of the plurality of second determination threshold values, the determination part compares values equivalent to capacitance between the plurality of first electrode pairs constituting each of the plurality of first electrode pair units with each of the plurality of threshold values, and the determination part determines liquid level corresponding to liquid quality based on the comparison results.

7. The capacitive liquid level detection device according to claim 1, wherein
the tank is a vehicle fuel tank having a depression in a bottom;
the capacitive liquid level detection device comprises an electrode unit fixed in a vertical gap between the depression of the tank and a ceiling of the tank; and
the electrode unit comprises
a unit body having a bar shape, comprising the plurality of electrode pairs, and having a lower end disposed in the depression, and
an urging member disposed at an upper end of the unit body, urging the unit body in an extension direction and exerting pressure to the ceiling of the tank.
